(19) United States
(12) Patent Application Publication
(10) Pub. No.: US 2006/0215681 A1
(43) Pub. Date: Sep. 28, 2006

(54) Transmission device and upgrade method thereof

(75) Inventors: Tsutomu Chikazawa, Yokohama (JP); Junichi Ishiwatari, Kawasaki (JP); Masakazu Bamba, Kawasaki (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/190,877

(22) Filed: Jul. 28, 2005

(30) Foreign Application Priority Data
Mar. 28, 2005 (JP) 2005-091007

(51) Int. Cl. H04B 1/56; H04L 12/56; H04L 12/28; H04L 5/14; H04J 3/22; H04J 3/16

(52) U.S. Cl. 370/424; 370/465; 370/276; 370/400; 370/404

(57) ABSTRACT

A transmission device comprises a plurality of types of exchangeable duplexed interface cards on a receiving side and a transmitting side; an STS or VC switch card having functions of setting a signal route between the interface cards by an STS or VC on the receiving side and the transmitting side and of switching over a duplexed system in at least one of an interface card unit, a line unit, an STS path unit and a VC path unit; and a monitoring portion controlling the STS switch card and the transmitting side interface cards upon switching, and setting a signal route. For upgrading the transmission device, when an interface card is upgraded in service by increasing a transmission capacity of the duplexed already-existing interface cards, an interface card on a standby side is exchanged with an interface card having a larger capacity, the monitoring portion performs the same setting as that of an interface card on an active side, switches over the interface card on the standby side to the active side as well as the interface card on the active side to the standby side, by controlling the STS or VC switch card and a switch portion of the transmitting side interface card, and exchanges the interface card with an interface card having the capacity.

### BACKGROUND OF THE INVENTION

1. Field of the Invention

The present invention relates to a transmission device and upgrade method thereof, an in particular to a transmission device which enables the transmission capacity of a line in service to be increased and an upgrade method for a usage of the transmission device.

Traffic such as represented by the Internet has been remarkably increasing, thereby requiring an increase of the transmission capacity (hereinafter, occasionally referred to as upgrade) of a transmission device and yet without service interruptions (in-service).

2 . Description of the Related Art

An in-service upgrade method of a transmission device conventionally known in the art includes a different system transition method in a ring transmission system disclosed in patent document 1 as listed below. This patent document 1 transitions from a ring transmission system configured by a Uni-directional Path Switched Ring (UPSR) system during a line in-service to that by a Bi-directional Line Switched Ring (BLSR) system.

Specifically, at first, a control card (1h) of the UPSR system is replaced by a control card of the BLSR system. Also, by switching over a path switch (1g), a multiplexing/demultiplexing conversion card (1e) of the UPSR system on a standby side is replaced by a first multiplexing/demultiplexing conversion card of the BLSR system set to perform the operation of the UPSR system. Also, by switching over the path switch (1g) again, a multiplexing/demultiplexing conversion card (1b) of the UPSR system on the standby side is replaced by a second multiplexing/demultiplexing conversion card of the BLSR system set to perform the operation of the UPSR system. Then, the first and the second multiplexing/demultiplexing conversion cards are made to perform the operation of the BLSR system, thereby changing the line arrangement from the UPSR system to the BLSR system.

For an alternate prior art example, there is an upgrade method of a transmission device as disclosed in patent document 2 as listed below. This patent document 2 employs an ADM device having a cross-connect function for both an existing transmission device (1A) and a newly added high-speed transmission device (2A), in which a signal wiring compatible with a low-speed side interface is arranged so that the low-speed side interface of the transmission device (1A) is mounted at a position where a high-speed side interface is mounted, whereby the existing transmission device mounts thereon only the low-speed interface device. A new transmission device with the high-speed interface mounted is added to the transmission device with only the low-speed side interface mounted to configure a high-speed transmitter utilizing the existing transmission device.
[Patent document 1] Japanese patent application laid-open No.9-214438
[Patent document 2] Japanese patent application laid-open No.8-335922

However, the upgrade method according to the above patent document 1 intends to increase a substantial transmission capacity by enhancing a line usage efficiency of network, which has a limitation for an increase mount of the transmission capacity because the interface card is not changed.

Also, the upgrade method according to the above patent document 2 intends to increase the transmission capacity by adding a high-speed device such that a existing transmission device is connected to a high-speed device, which increases the volume of the device as well together with increasing the transmission capacity. Also upon increasing the transmission capacity while the interface card is changed, a duplexing system using different types of interface cards is not realized, so that an existing setting is removed or replaced by a new setting with an interface card of a larger capacity, so that a service interruption is caused between the setting removal to the new setting.

### SUMMARY OF THE INVENTION

It is accordingly an object of the present invention to provide a transmission device and upgrade method thereof which enables an upgrade in service without increasing the volume of the device.

In order to achieve the above object, a transmission device according to one preferred mode of the present invention comprises a plurality of types of exchangeable duplexed interface cards on a receiving side and a transmitting side; a transport unit switch card having functions of setting a signal route in a synchronous digital network by a transport unit between the interface cards on the receiving side and the transmitting side and of switching over a duplexed system in or by at least one of an interface card unit, a line unit and a path unit; and a monitoring portion setting, when one of the duplexed interface cards is exchanged with an interface card of another type, according to a setting of another interface card of the duplexed interface cards, the transport unit switch card and the exchanged interface card.

Also, a transmission device according to one preferred mode of the present invention comprises a plurality of types of exchangeable duplexed interface cards on a receiving side and a transmitting side; a transport unit switch card having functions of setting a signal route by a transport unit of a synchronous digital network between the interface cards on the receiving side and the transmitting side and of switching over a duplexed system in at least one of an interface card unit, a line unit and a path unit; and a monitoring portion controlling the transport unit switch card and the transmitting side interface card upon switching, and setting a signal route.

In an upgrade method of the transmission device according to one preferred mode of the present invention, schematically, interface cards duplexed are exchanged one after the other in such a way that an interface card on a standby side is exchanged and made active while the unexchanged card that has been active so far is made standby and then exchanged.

This upgrade method may execute the following various operations:

A duplexed pair in the process of exchange (upgrade) of the interface cards have mutually different transmission capacities, in which the same setting for the existing line capacity is converted and set to the new interface card, and a line capacity portion to be increased (increment) is set as non-use (unused one). A new setting for the increment in the process of upgrade is not allowed in the absence of an interface card to be duplexed, and a setting for the increment after the completion of upgrade is allowed.

Settings necessary for using new interface cards are for SOH (Section Over Head) and LOH (Line Over Head) in SONET (Synchronous Optical NETwork), or SDH (Synchronous Digital Hierarchy) as a synchronous digital network as well as for STS (Synchronous Transport Signal) path as a transport unit in SONET or VC (Virtual Container) path as a transport unit in SDH, in which the settings for the existing lines are different from the non-use settings for the increment applied to the new interface cards, depending on the types of interface cards to be exchanged.

For example, when the upgrade is performed from OC3 (Optical Carrier 3: synchronous transport module STM-1 in SDH) to OC12 (STM-4 in SDH) in SONET, the settings for SOH and LOH upon increasing the transmission capacity (bit rate) are the same as those for the existing lines, and the settings for the existing line capacity concerning STS path (VC path in SDH) are the same as those for the existing lines, so that the non-use settings are made for such a line capacity to be increased.

Also for example, when the number of port equipped for the interface cards is increased in such a way that the upgrade is made from Single OC12 (interface card having a single interface of OC12) to Quad OC12 (interface card having four interface cards of OC12), the settings only for the existing port number are the same as those for the existing lines, so that the non-use settings for the increment are made for SOH and LOH as well as STS path (or VC path). When the transmission capacity and the port number are changed together, the above mentioned two settings are to be combined.

In case where an STS (or VC) switch card is duplexed while the physical sizes of the interface cards to be upgraded are different or the position of slot to be mounted is changed by the upgrade, the routes through which traffic passes within the transmission device are changed, so that the settings for the STS (or VC) switch cards are also changed. This will change a switch for switching the duplexing operation, affecting the traffic passing through the interface card on the active side.

For avoiding this affection, when the transport unit switch card is duplexed, and the interface card is exchanged with an interface card whose physical size is different or a slot of the interface card is shifted together with the upgrade, the monitoring portion leaves an old setting on an active side of the STS or VC switch card duplexed, performs a new setting on a standby side, switches over between the duplexed transport unit switch cards by controlling the transmitting side interface card, and performs the new setting to one of the old setting transport unit switch cards.

When upgrading the STS switch cards, the STS or VC switch card STS-SW duplexed on the standby side is exchanged to a new STS or VC switch card STS-SW and is given the same settings as the old STS or VC switch card STS-SW. Then, the old STS or VC switch card is exchanged to a new STS or VC switch card, thereby enabling an in-service exchange.

For means preventing line disconnections due to mis-operations, a function restoring the settings before upgrading is provided.

The transmission device has a function of inserting/drawing interface cards or restoring from power interruptions by recording the settings in a database within the monitoring portion. Between commencement and completion of the upgrade, settings for the interface cards to be upgraded are not recorded in the database but are recorded in the database at that time of completion of the upgrade.

Thus, only by recalling the settings recorded in the database, it is made possible to restore the original settings.

Operations in the process of upgrade which are different from the normal state, namely, interface card type change in service, duplexing of different types of interface cards, existing settings for new interface cards, non-use settings for the increment, new/old settings for transport unit switch cards, and non-upgrade of the database are performed to explicitly notify an user of the process of upgrade, the upgrade mode being performed by the monitoring portion.

The above constitution of the present invention enables the duplexed state to be held even in the process of upgrade and a switchover to be made upon failure, interface cards to be exchanged in service and the transmission capacity to be increased or upgraded, and such an in-service upgrade to be realized with less space. Also it enables the state before the upgrade to be easily restored when the unexpected happens. It is to be noted that a protection side interface card is firstly exchanged in this description, while the working side interface card may be firstly exchanged, providing the same effects.

### BRIEF DESCRIPTION OF THE DRAWINGS

The above and other objects and advantages of the invention will be apparent upon consideration of the following detailed description, taken in conjunction with the accompanying drawings, in which:

FIG. 1 is a block diagram showing a constitutional embodiment of a transmission device according to the present invention;

FIG. 2 is a detailed arrangement of a switch portion;

FIG. 3A is a block diagram showing a signal flow of a switch portion (SW) in which a 1+1 line switch is used;

FIG. 3B is a block diagram showing a signal flow of a bridge portion (BR) in which a 1+1 line switch is used;

FIG. 4A is a block diagram showing a signal flow of a switch portion (SW) used in UPSR or without duplexing;

FIG. 4B is a block diagram showing a signal flow of a bridge portion (BR) used in UPSR or without duplexing;

FIG. 5 is a flow chart showing a process of in-service upgrade of a transmission device according to the present invention;

FIGS. 6A-6D are block diagrams showing an upgrade process in which a 1+1 line switch of OC12 is upgraded to OC48;

FIGS. 7A-7C are block diagrams showing a process in which a UPSR ring network arrangement of OC12 is upgraded to OC48;

FIG. 8 is a block diagram showing a network arrangement in which OC12 in FIG. 7 is upgraded to Quad OC12 in line unit;

FIGS. 9A and 9B are block diagrams respectively showing a slot arrangement of an interface card in FIGS. 6A-6D, as well as signal routes of interface cards and STS switch cards in this slot arrangement;

FIGS. 10A and 10B are block diagrams respectively showing a slot embodiment of an interface card when OC48 of a slot 4 in FIG. 9 is upgraded to OC192 in STS/VC path unit, as well as signal routes of interface cards and STS switch cards in this slot arrangement; and

FIGS. 11A and 11B are block diagrams respectively showing a slot embodiment of an interface card when OC48 of slot 3 in FIG. 10 is upgraded to OC192, as well as signal routes of interface cards and STS cards in this slot arrangement.

### DESCRIPTION OF THE EMBODIMENTS

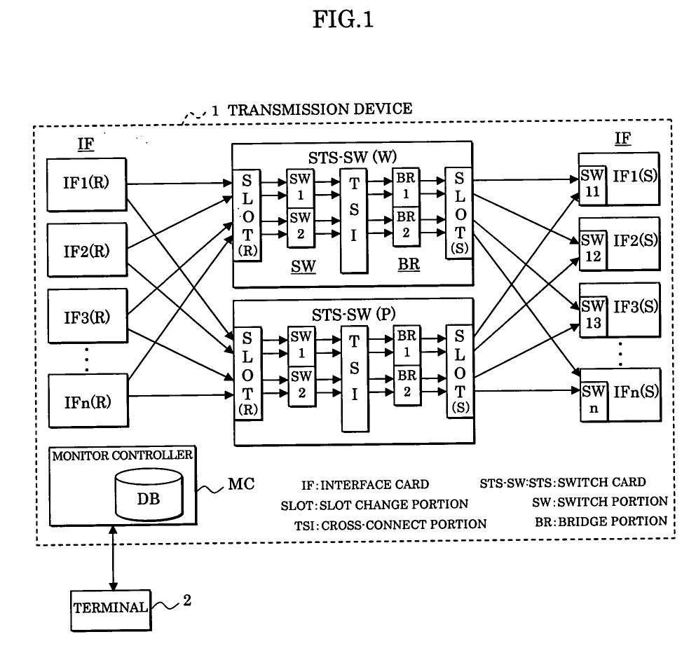

FIG. 1 shows one embodiment of a transmission device according to the present invention. This transmission device 1 includes a plurality of interface cards IF1 (R)-IFn(R) (hereinafter, occasionally represented by IF(R) or IF) as well as IF1(S)-IFn(S) (hereinafter, occasionally represented by IF(S) or IF), duplexed STS switch cards STS-SW(W) (working side) as well as STS-SW(P) (protection side), and a monitor controller MC. It is to be noted that the present invention is applicable to not only a synchronous transport signal (STS) that is a transport unit in SONET as a synchronous digital network, but also to a virtual container (VC) that is a transport unit in SDH, where in the following descriptions, “STS” is represented, and that the STS cards STS-SW may not be duplexed.

As regards an interface card, for example, the interface cards IF1(R) & IF2(R), and IF3(R) & IF4(R), . . . are respectively duplexed for a working side and a protection side. For example, IF1(R) is for the working side and IF2(R) is for the protection side, forming a pair of duplexed arrangement. Also, the interface cards IF1(S) & IF2(S), and IF3(S) & IF4(S) . . . are also duplexed, respectively.

Generally, the function of the interface card on an input side (receiving side) (for example, IF1(R)) and the function of the interface card on an output side (transmitting side) (for example, IF1(S)) are both provided in a single interface card.

The STS switch cards STS-SW(W) and (P) (hereinafter, occasionally represented by STS-SW) respectively have slot change portions SLOT(R) and SLOT(S) whose logical slot positions are changeable, switch portions SW1 and SW2 (hereinafter, occasionally represented by SW) which select a signal from the duplexed interface card IF(R) in STS unit, a cross-connect portion TSI (Time Slot Interchange) of the STS unit, and a bridge portions BR1 and BR2 (hereinafter, occasionally represented by BR) which distributes the signal to the duplexed interface cards IF(S). The monitor controller MC has a database DB for saving setting data to the interface cards IF and the STS switch cards STS-SW as indicated in the following Table 1, and is connected to an external terminal 2. It is to be noted that the interface cards IF(S) on the receiving side are respectively provided with switch portions SW11-SWn which select one of the outputs from the duplexed STS switch cards STS-SW(W) (working side) and STS-SW(P) (protection side).

TABLE 1
CONTENTS OF DB IN MC

| TYPE OF | |
|---|---|
| INFORMATION TO BE | DETAILS OF INFORMATION TO BE |
| SAVED | SAVED |
| TYPE OF IF CARD | TRANSMISSION RATE (OC3, OC12, OC48, |
| MOUNTED IN SLOT | OC192 ETC.) |
| | NUMBER OF PORT OF SINGLE CARD |
| DUPLEX SETTING | SLOT POSITION FOR WORKING |
| | SLOT POSITION FOR PROTECTION |
| | PORT NO. TO BE DUPLEXED |
| | TYPE OF DUPLEXING (1 + 1, UPSR, |
| | BLSR ETC.) |
| CROSS-CONNECT | SLOT NO., PORT NO., & STS CHANNEL |
| SETTING | NO. OF CONNECTION SOURCE AND |
| | DESTINATION |

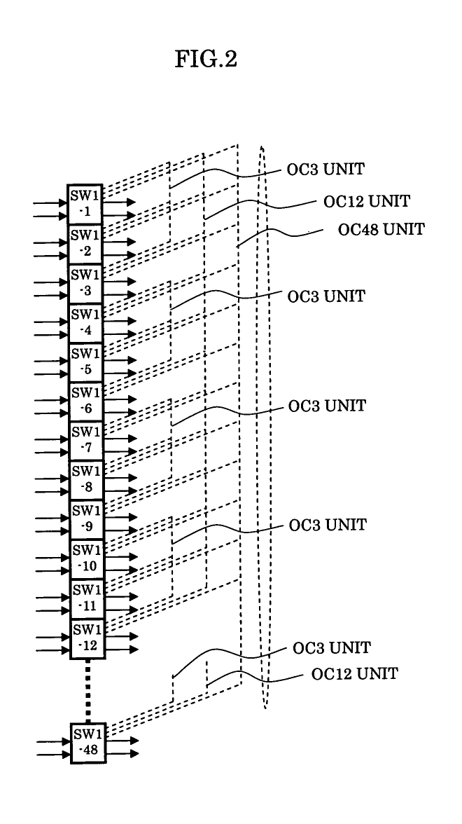

The switch portion SW of the STS switch card STS-SW shown in FIG. 1 includes 48 switches of the STS unit (STS-1) in series for example as shown in FIG. 2 in case where the maximum capacity of the interface cards IF are OC48. This switch portion SW may be set with the number of switch operated at once according to the types of the interface cards IF in OC3 unit, OC12 unit, or OC48 unit as shown in FIG. 2 by dotted lines. The bridge portion BR has the same arrangement.

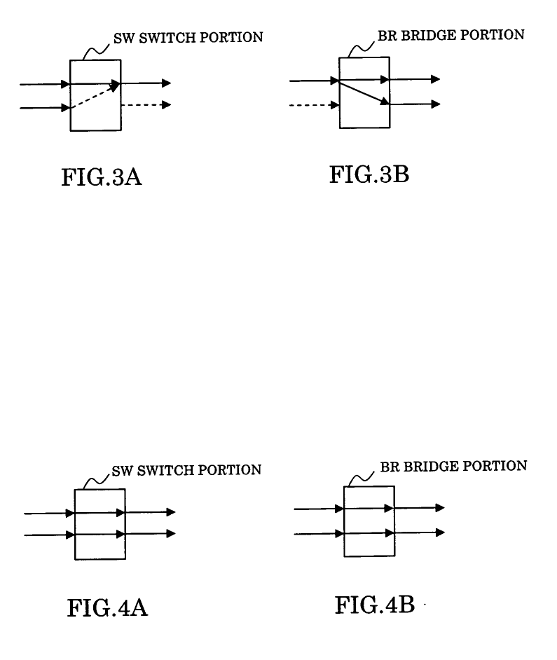

If the duplexing is performed with line switches prescribed by SONET or the like, any two of the interface cards IF as a pair are connected through the slot change portion SLOT to the switch portion SW or the bridge portion BR, in which the switch portion SW selects a signal from two inputs as shown in FIG. 3A in order to attend to a 1+1 duplexing system, and the bridge portion distributes the signal as shown in FIG. 3B.

In case where the duplexing is performed with the STS switch card STS-SW (UPSR duplexing system), as shown in FIGS. 4A and 4B, the switch portion SW and the bridge portion BR respectively have a straight connection or through connection, forming to select arbitrary paths as a pair at the slot change portion TSI.

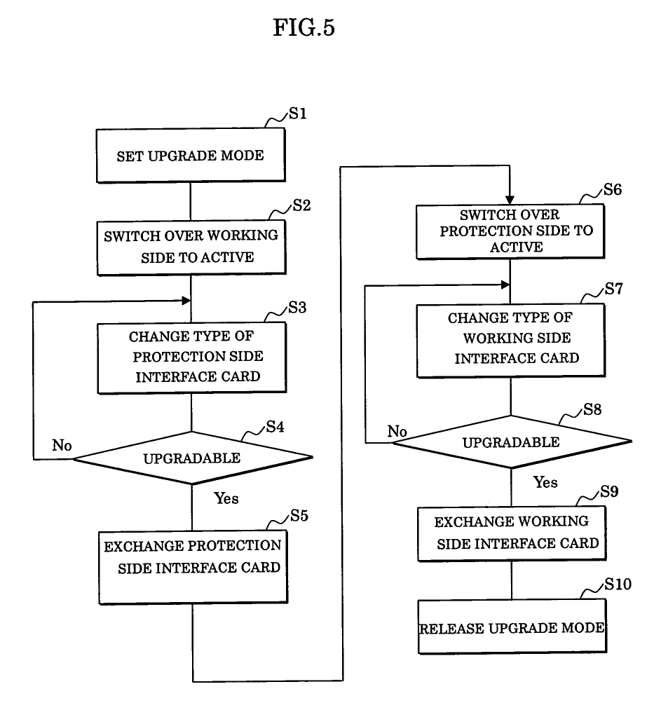

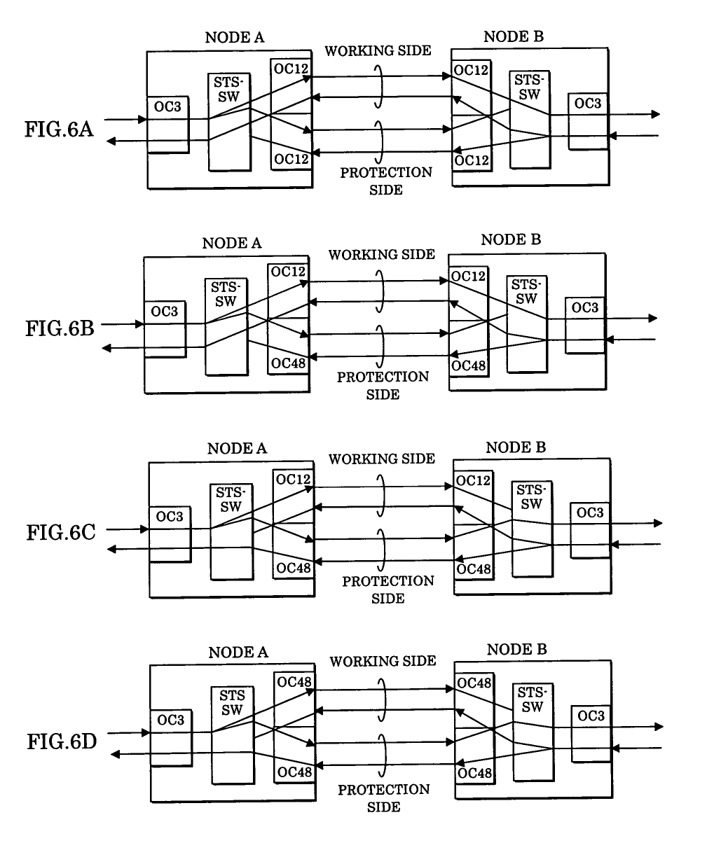

FIG. 5 shows a process (steps S1-S10) of an in-service upgrade method in a transmission device according to the present invention as described above. Hereinafter, this in-service upgrade process will be described referring to FIG. 6 (1+1 duplexing switchover system) illustrating an upgrade example of an OC12 card duplexed with a 1+1 line switch prescribed by SONET to an OC48 card. It is to be noted that a node A or B shown in FIGS. 6A-6D respectively correspond to the transmission device shown in FIG. 1 where there is a single STS switch card, and that the following Tables 2-4 show setting contents (settings) in the database DB with respect to the STS switch card STS-SW and the interface cards IF in the in-service upgrade process.

TABLE 2
SETTINGS IN IN-SERVICE UPGRADE PROCESS

| | DB CHANGE | SETTING | |
|---|---|---|---|
| PROCESS | CONTENTS | OF STS-SW | SETTING OF IF |
| 1 | UPGRADE MODE | NO CHANGE | NO CHANGE |
| 2 | NO CHANGE | SELECT | NO CHANGE |
| | | WORKING | |
| | | SIDE* | |
| 3 | NO CHANGE | SEE TABLE 3 | SEE TABLE 4 |
| 4 | NO CHANGE | NO CHANGE | NO CHANGE |
| 5 | NO CHANGE | SELECT | NO CHANGE |
| | | PROTECITON | |
| | | SIDE* | |
| 6 | NO CHANGE | SEE TABLE 3 | SEE TABLE 4 |
| 7 | NO CHANGE | NO CHANGE | NO CHANGE |
| 8 | RELEASE UPGRADE | NO CHANGE | NO CHANGE |
| | MODE, TYPE OF IF | | |
| | CARD MOUNTED IN | | |
| | SLOT, DUPLEXING, | | |
| | CROSS-CONNECT | | |

*CONTROL CROSS-CONNECT PORTION UPON UPSR; CONTROL SW PORTION UPON 1 + 1

TABLE 3
SETTINGS OF STS-SW

| | | SETTING OF STS-SW | | |
|---|---|---|---|---|
| | | | SWITCH | |
| | | | PORTION & | |
| TYPE OF | TYPE OF | SLOT CHANGE | BRIDGE | CROSS-CONNECT |
| UPGRADE | DUPLEX | PORTION | PORTION | PORTION |
| UPON | 1 + 1* | NEWLY | NEW CAPACITY | EXISTING PORTION |
| INCREASING | | MOUNTED | PORTION BY 1 + 1 | UNCHANGED |
| CAPACITY | | SLOT | OPERATION | INCREMENT |
| (BIT RATE) | | | | UNEQUIPPED |
| | UPSR | NEWLY | NEW CAPACITY | EXISTING PORTION |
| | | MOUNTED | PORTION | UNCHANGED |
| | | SLOT | UNDUPLEXED | INCREMENT |
| | | | | UNEQUIPPED |
| UPON | 1 + 1* | NEWLY | EXISTING PORT | EXISTING PORTION |
| INCREASING | | MOUNTED | UNCHANGED | UNCHANGED |
| NUMBER OF | | SLOT | ADDED PORT | INCREMENT |
| PORT | | | UNDUPLEXED | UNEQUIPPED |
| | UPSR | NEWLY | NO CHANGE | EXISTING PORTION |
| | | MOUNTED | ADDED PORT | UNCHANGED |
| | | SLOT | UNDUPLEXED | INCREMENT |
| | | | UNEQUIPPED | |

*NO SETTING CHANGE AT TIME OF CHANGING TYPE OF IF CARD (W)

TABLE 4

| TYPE OF | TYPE OF | |
|---|---|---|
| UPGRADE | DUPLEX | SETTING OF IF |
| UPON | 1 + 1 | NO CHANGE |
| INCREASING | UPSR | NO CHANGE |
| CAPACITY | | |
| (BIT RATE) | | |
| UPON | 1 + 1 | EXISTING PORTION UNCHANGED |
| INCREASING | | NONUSE SETTING FOR ADDED PORTS |
| NUMBER OF | | BY SOH & LOH |
| PORT | | PRESCRIBED BY SONET |
| | UPSR | EXISTING PORTION UNCHANGED |
| | | NONUSE SETTING FOR ADDED PORTS |
| | | BY SOH & LOH |
| | | PRESCRIBED BY SONET |

Step S1:

Normally, for preventing a line disconnection due to casual setting change, the transmission device 1 does not make a change setting for the type of the interface card in a state (in-service state) where a cross-connect setting is made at the cross-connect portion TSI, whereas in the upgrade mode set, the transmission device 1 allows the interface card-type change setting even in the in-service state but instead does not save the interface card type-change setting in the database DB.

Step S2:

The working side is switched over to the active state so that the connection of the switch portion SW of the STS switch card STS-SW may have solid lines shown in FIG. 3A, making the protection side the standby state (see FIG. 6A).

Steps S3, S4:

The type of the interface card on the protection side now made the standby state is changed to OC48. If it is impossible to upgrade the type of the interface card designated to be changed, the process does not go to the next step. If the interface card on the active side is OC12, for example, as shown in FIG. 6B, when an interface card is designated which passes a signal of a type that is not OC3 or SONET with the capacity decreasing, it is determined to be impossible to make such an upgrade. Accordingly, at the time when an interface card type capable of making the upgrade is designated to be changed, it is determined whether the type of upgrade requests to increase the bit rate or the number of port, or both of them.

Step S5:

The interface card on the protection side is exchanged (see FIG. 6B). Since the transmission device conventionally has a function of not writing the settings in the interface card in a mis-mounting state where the interface card type set is different from the interface card type mounted, the process can go to the next step even if the order of the change setting of interface card type and interface card exchange is reversed.

If setting interface card type change is made in advance, the interface card on the protection side already provided at that time is still an OC12 card, forming a mis-mounting, so that new settings are not written in the interface card but are to be written at the time of exchange of the interface card.

If the exchange of the interface card is made in advance, the OC48 card that is an interface card on the new protection side is found to be mis-mounted and the existing settings are not written in the interface card, so that new settings are to be written in the interface card at the time when the interface card type change is made.

At the time when the setting of interface card type change is made, settings for operations by OC48 unit are written in the switch portion SW and the bridge portion BR in the STS switch card STS-SW in conformity with the condition given in the above Table 3. STS channels ch1 to ch12 of the cross-connect portion TSI are left as they are because of the existing settings for the previous OC12 card, so that Unequipped settings indicating non-use state are written for STS channels ch13-ch48 providing a new capacity portion. If the physical size and the mounting position of the new interface card are the same as those of the existing interface card, the settings for the slot change portion SLOT are not changed. At the time when the settings for the interface card type change and the interface card exchange are made, SOH/LOH settings are written in the interface card in the same as the existing interface card under the conditions given in the above Table 4.

At this time, as shown in FIG. 6B, data transport is made between the OC48 cards on the protection side in the same manner as between the OC12 cards on the working side, providing an arrangement not selected by the switch portion on the receiving side. Namely, between the working side lines (OC12) and the protection side lines (OC48) having different capacities, the 1+1 line switchover becomes possible for the capacity OC12.

Step S6:

The connection of the switch portion SW at the STS switch card STS-SW is switched over to select the dotted line side in FIG. 3A to make the working side the standby state, thereby making the protection side active (see FIG. 6C).

As described above, this switchover can be made according to the 1+1 line switchover method prescribed by SONET/SDH.

Steps S7 and S8:

The interface card type on the working side now made the standby state is changed to OC48.

If the type of the designated interface card to be changed can not be upgraded, the process does not go to the next step. Since the interface card after the completion of upgrade is required to be the same type as the previous one, in case where the interface card on the active side (protection side at this time) is of OC48, it is determined impossible to make an upgrade if a different interface card such as an OC12 card is designated.

Step S9:

The interface card on the working side is exchanged (see FIG. 6D). The same SOH and LOH settings as those of the existing interface card are written in the interface card under the conditions given in the above Table 4 at the time of setting the interface card-type change and exchanging the interface card.

In case of the 1+1 line switch duplexed, the settings of the slot change portion SLOT, the switch portion SW, the bridge portion BR, and the cross-connect portion TSI form a single combination of the interface cards on the working side and the protection side, so that as indicated in the footnote of Table 3, no setting change is made for the STS switch card at the time of setting the interface card-type change on the protection side.

Step S10:

Releasing the upgrade mode disables the interface card-type change to be set in the in-service state, thereby writing the setting change of the process so far in the database for the determination.

At the termination of the above process, as shown in FIG. 6D, the working side assumes the standby state and the protection side assumes the active state. If necessary, a process may be added by which the working side is switched over to the active state and the protection side is switched over to the standby state.

Thus, the interface card IF can be exchanged in-service.

Example of UPSR Upgrade

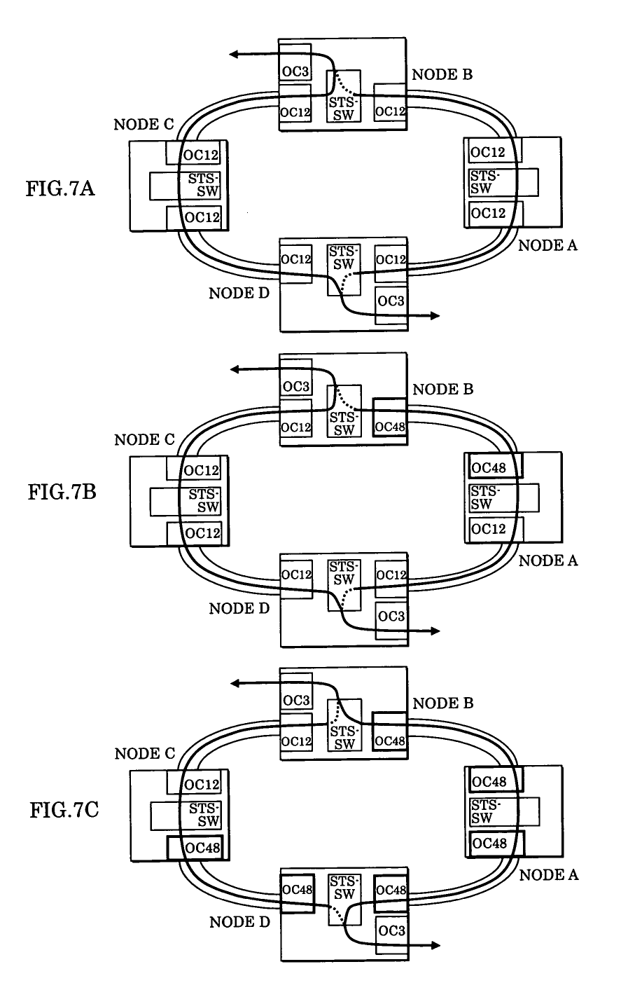

An embodiment of a process for executing an upgrade of an OC12 ring network to an OC48 ring network according to the present invention will now be described referring to FIGS. 7A-7C.

FIG. 7A shows one example of an OC12 ring network configuration prior to upgrade, FIG. 7B shows one example of same in the process of upgrade, and FIG. 7C shows one example of same in the process of upgrade further advanced from the upgrade process shown in FIG. 7B. In this example where the settings of the cross-connect portion TSI of the STS switch card STS-SW are made, the process of upgrading an OC12 interface card connecting the node A with the node D to an OC48 interface card by STS path unit will be described.

At first, as shown in FIG. 7A, the STS switch cards STS-SW of the nodes D and B are switched over to pass a signal through a route of node B-node C-node D, thereby assuming a state where a signal is not selected between node A-node D as shown by dotted lines.

Then, the upgrade mode is set in the nodes A and B, assuming a state enabling the interface card-type change to be set, whereby the settings of the interface card type is changed to those of the OC48 card as shown by thick lines in FIG. 7B to perform exchanging the interface card and connecting optical fibers.

At this time, the same settings as those of SOH and LOH for the OC12 interface card are converted and set to the OC48 interface card. Regarding the STS switch card STS-SW, the settings of the STS channels ch1 to ch12 of the OC12 interface card are converted and set to the STS channels ch1-ch12 of the OC48 interface card, thereby making Unequipped (UNEQ) setting indicating that they are not used for the STS channels ch13-ch48.

Upgrade between the node A-node D is executed in the same process.

Next, a process of upgrading the OC12 interface card connecting the node B with the node C to the OC48 interface card will be described hereinbelow.

By switching over the STS switch cards STS-SW of the nodes D and B, a signal is passed through a route of node B-node A-node D as shown by solid lines in FIG. 7C to assume a state where no signal route is formed between node D-node C, followed by upgrade process in the same manner, thereby realizing a network configuration as shown in FIG. 7C.

In the same process, the upgrade is executed also between node C-node D. After the completion of entire upgrade, the upgrade mode is released for all of the nodes to establish the setting of the interface card type and the STS channels, resulting in the end of the process.

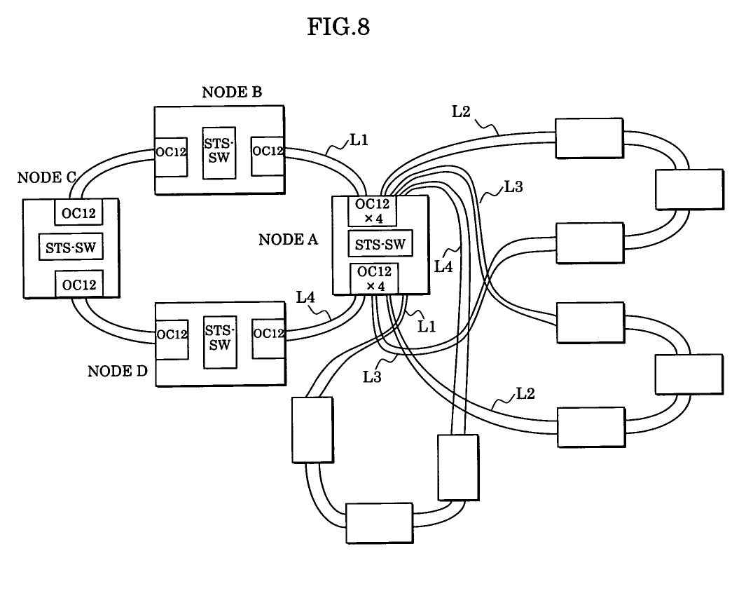

FIG. 8 shows one example of a network configuration in which the OC12 interface cards shown in FIG. 7 are upgraded to Quad OC12 interface cards accommodating four OC12 interface cards in a single card and then a different network is connected to the ports increased. Namely, this is to switch over the upgrade by line unit.

The upgrade process of this case is the same as what have been described in the above, where at the time of setting the interface card-type change, the same settings as those of SOH and LOH previously set for the OC12 interface card are converted and set to a line L1 of the Quad OC12 interface card; “Out of Service” is set for lines L2-L4; in the STS switch card STS-SW the settings of the STS channels ch1 to ch12 of the OC12 interface card are converted and set to the STS channels ch1 to ch12 of the line L1 of the Quad OC12 interface card; and the Unequipped (UNEQ) setting is made to indicate that they are not used for the STS channels ch1 to ch12 of lines L2-L4.

Example of 1+1 Upgrade

A process of upgrading an OC48 1+1 network to an OC192 1+1 network according to the present invention will now be described. It is to be noted that this 1+1 duplexing switchover system is the same as shown in FIG. 6 in respect of network configuration, where it is different that the STS switch card STS-SW is duplexed for a working side (W) and a protection side (P).

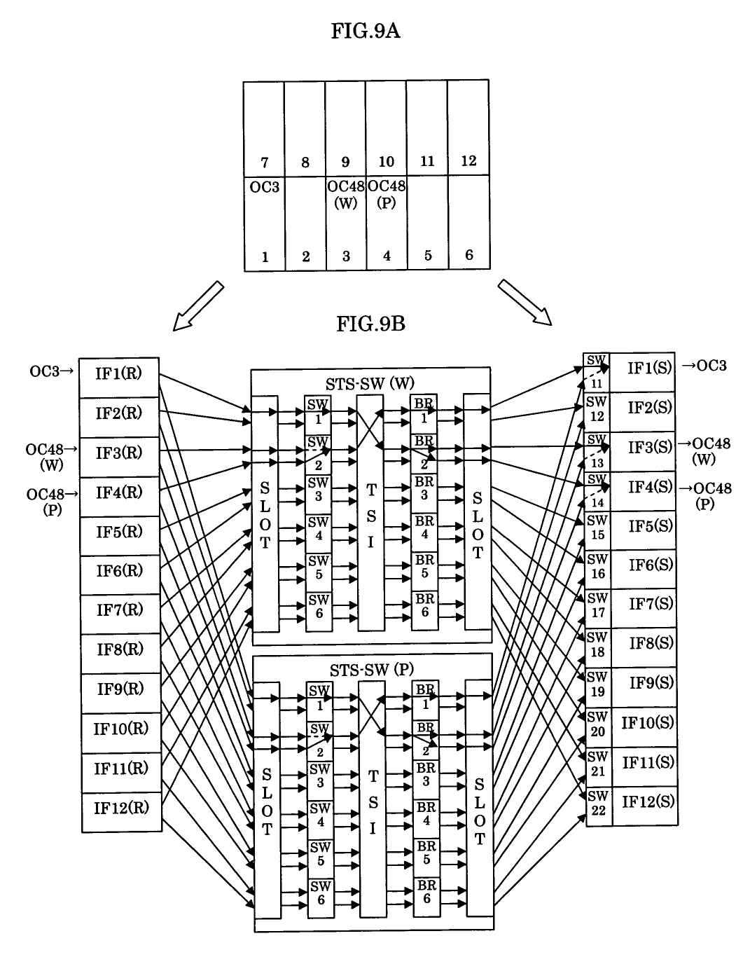

FIG. 9A shows one example of a slot arrangement of an interface card mounted on the transmission device 1, in which an OC3 interface card is mounted in a card slot 1, and OC48 interface cards on the working side and the protection side are respectively mounted in card slots 3 and 4.

FIG. 9B shows signal routes of the STS switch cards STS-SW in FIG. 9A.

The upgrade process is the same as that from FIG. 6A to FIG. 6D, where since the physical sizes of the interface cards IF are different in this example, it is necessary to change the settings for the slot change portion SLOT, the switch portion SW, and the bridge portion BR of the STS switch cards STS-SW at step S3 in FIG. 5.

It is to be noted that the card slots shown in FIG. 9A are common to the interface cards IF(R) on the receiving side and the interface cards IF(S) on the transmitting side. However, in this example, the maximum transmission capacity of a single slot is OC48, so that for example the interface card IF4(R) even if it is of OC48 may be connected to the interface cared IF1(S) of OC3 as shown in FIG. 9B, where in this case the transmission capacity is limited to OC3 in the same example as FIG. 6.

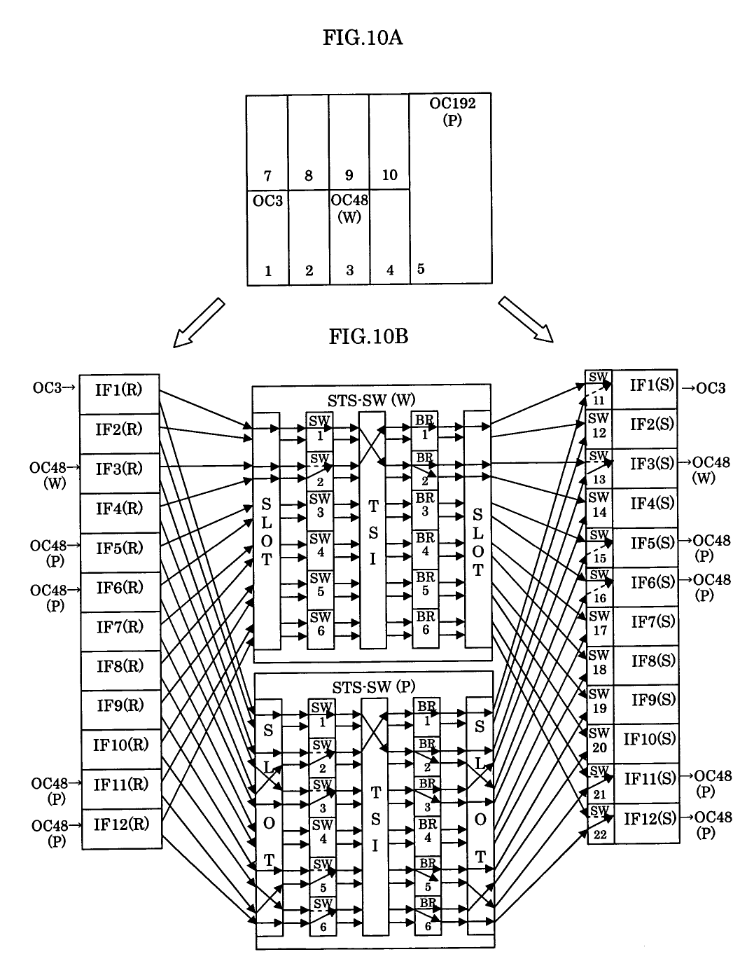

FIG. 10A shows one example in which an OC192(P) interface card is mounted in slots 5, 6, 11, 12 instead of the OC48(P) interface card mounted in the card slot 4 at step S3 in FIG. 5.

FIG. 10B shows signal routes of the STS switch cards STS-SW in FIG. 10A.

At step S3 in FIG. 5, the settings of the slot change portion SLOT, the switch portion SW, and the bridge portion BR when the OC192 interface card is used for the STS switch card STS-SW(P) on the protection side are written, the STS switch card STS-SW(P) on the protection side is selected by controlling the switches SW11-22 of the interface card IF(S), and then the same settings are written in the STS switch card STS-SW(W) on the working side, whereby the same effect is achieved as instantaneous change of the settings for the STS switch card STS-SW.

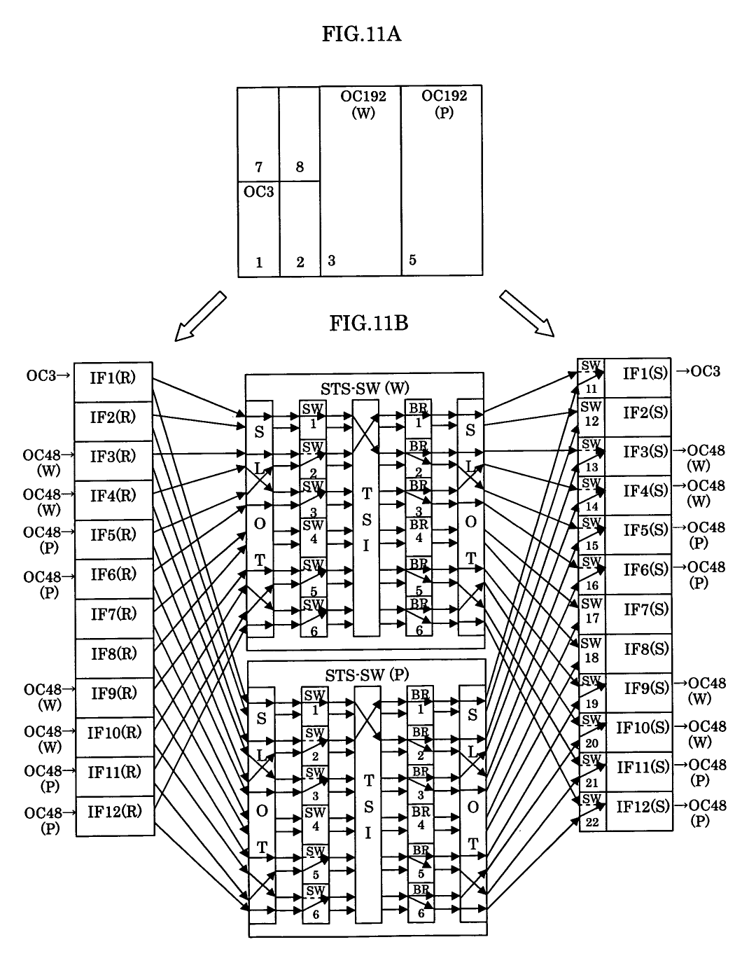

FIG. 11A shows one example in which the OC192 interface cards are mounted in slots 3, 4, 9, and 10 after executing the same upgrade process as the above description. FIG. 11B shows signal routes of the STS switch cards STS-SW in FIG. 11A.

As above described, by exchanging interface cards as they are mounted on the existing device, an in-service upgrade can be realized with less space.

What is claimed is:

1. A transmission device comprising:
a plurality of types of exchangeable duplexed interface cards on a receiving side and a transmitting side;
a transport unit switch card having functions of setting a signal route in a synchronous digital network by a transport unit between the interface cards on the receiving side and the transmitting side and of switching over a duplexed system in at least one of an interface card unit, a line unit and a path unit; and
a monitoring portion setting, when one of the duplexed interface cards is exchanged with an interface card of another type, according to a setting of another interface card of the duplexed interface cards, the transport unit switch card and the exchanged interface card.

2. A transmission device comprising:
a plurality of types of exchangeable duplexed interface cards on a receiving side and a transmitting side;
a transport unit switch card having functions of setting a signal route by a transport unit of a synchronous digital network between the interface cards on the receiving side and the transmitting side and of switching over a duplexed system in at least one of an interface card unit, a line unit and a path unit; and
a monitoring portion controlling the transport unit switch card and the transmitting side interface card upon switching, and setting a signal route.

3. An upgrade method of the transmission device as claimed in claim 1 comprising the steps of
when the duplexed interface cards in service are upgraded by increasing a transmission capacity of the duplexed interface cards,
exchanging an interface card on a standby side with an interface card having a larger capacity;
performing a same setting, at the monitoring portion, as a setting of an interface card on an active side;
switching over, at the monitoring portion, the interface card on the standby side to the active side, and the interface card on the active side to the standby side, by controlling the transport unit switch card and the transmitting side interface card; and
exchanging the interface card switched over to the standby side with an interface card having the capacity.

4. An upgrade method of the transmission device as claimed in claim 1 comprising the steps of
when the transport unit switch card is duplexed, and the interface card is exchanged with an interface card whose physical size is different or a slot of the interface card is shifted together with an upgrade,
leaving, at the monitoring portion, an old setting on an active side of the transport unit switch card duplexed, and performing a new setting on a standby side;
switching over between the duplexed transport unit switch cards by controlling the transmitting side interface card; and
performing the new setting to one of the old setting transport unit switch cards.

5. An upgrade method of the transmission device as claimed in claim 1 comprising the steps of.
when the transport unit switch cards are duplexed and the transport unit in service is upgraded by increasing a transmission capacity thereof,
exchanging a transport unit switch card on a standby side with a transport unit switch card having a larger capacity;
performing a same setting, at the monitoring portion, as a setting of a transport unit switch card on an active side;
switching over, at the monitoring portion, the transport unit switch card on the standby side to an active side, and the transport unit switch card on the active side to the standby side, by controlling the transmitting side interface card; and
exchanging the transport unit switch card switched over to the standby side with the transport unit switch card having the capacity.

6. The upgrade method of the transmission device as claimed in claim 3, wherein the monitoring portion has a database, setting for each card is not recorded in the database before a completion of the upgrade, but is recorded in the database at a time of the completion of the upgrade.

7. The upgrade method of the transmission device as claimed in claim 4, wherein the monitoring portion has a database, setting for each card is not recorded in the database before a completion of the upgrade, but is recorded in the database at a time of the completion of the upgrade.

8. The upgrade method of the transmission device as claimed in claim 5, wherein the monitoring portion has a database, setting for each card is not recorded in the database before a completion of the upgrade, but is recorded in the database at a time of the completion of the upgrade.

9. The upgrade method of the transmission device as claimed in claim 3, wherein the exchange, setting and switchover are enabled only during upgrading, and an update of the database is disabled, an upgrade mode is set to the monitoring portion in order to indicate to a user that the interface card is being upgraded.

10. The upgrade method of the transmission device as claimed in claim 4, wherein the exchange, setting and switchover are enabled only during upgrading, and an update of the database is disabled, an upgrade mode is set to the monitoring portion in order to indicate to a user that the interface card is being upgraded.

11. The upgrade method of the transmission device as claimed in claim 5, wherein the exchange, setting and switchover are enabled only during upgrading, and an update of the database is disabled, an upgrade mode is set to the monitoring portion in order to indicate to a user that the interface card is being upgraded.

12. The upgrade method of the transmission device as claimed in claim 3, wherein the upgrade is performed by exchanging the interface card with an interface card whose rate of an optical carrier (OC-n) that is a user network interface in a SONET or whose rate of a synchronous transport module (STM-n) that is a user network interface in an SDH is high.

13. The upgrade method of the transmission device as claimed in claim 4, wherein the upgrade is performed by exchanging the interface card with an interface card whose rate of an optical carrier (OC-n) that is a user network interface in a SONET or whose rate of a synchronous transport module (STM-n) that is a user network interface in an SDH is high.

14. The upgrade method of the transmission device as claimed in claim 5, wherein the upgrade is performed by exchanging the interface card with an interface card whose rate of an optical carrier (OC-n) that is a user network interface in a SONET or whose rate of a synchronous transport module (STM-n) that is a user network interface in an SDH is high.

15. The upgrade method of the transmission device as claimed in claim 3, wherein the upgrade is performed by exchanging the interface card with an interface card having a larger number of ports which can be accommodated in a single interface card.

16. The upgrade method of the transmission device as claimed in claim 4, wherein the upgrade is performed by exchanging the interface card with an interface card having a larger number of ports which can be accommodated in a single interface card.

17. The upgrade method of the transmission device as claimed in claim 5, wherein the upgrade is performed by exchanging the interface card with an interface card having a larger number of ports which can be accommodated in a single interface card.

18. The upgrade method of the transmission device as claimed in any one of claims 3, wherein by the upgrade the interface card is exchanged with an interface card whose physical size is smaller and an available card slot is secured.

19. The transmission device as claimed in claim 1, wherein the synchronous digital network comprises a SONET (Synchronous Optical NETwork) or an SDH (Synchronous Digital Hierarchy), and the transport unit comprises a synchronous transport signal (STS) and a virtual container (VC), respectively.
